(19) United States
(12) Patent Application Publication
(10) Pub. No.: US 2017/0309304 A1
(43) Pub. Date: Oct. 26, 2017

(54) HARDWARE BASED CROSSTALK REDUCTION FOR HARD DISK DRIVES

(71) Applicant: Agency For Science, Technology And Research, Singapore (SG)

(72) Inventors: Chye Chin TAN, Singapore (SG); Ming Chou LIN, Singapore (SG)

(21) Appl. No.: 15/509,909

(22) PCT Filed: Oct. 2, 2015
(86) PCT No.: PCT/SG2015/050364

§ 371 Date: Mar. 9, 2017

(30) Foreign Application Priority Data
Oct. 3, 2014 (SG) 10201406341W

(51) Int. Cl. G11B 5/55

(52) U.S. Cl. CPC G11B 5/5565; G11B 5/5573; G11B 5/5578

(57) ABSTRACT

An actuator assembly for crosstalk reduction in hard disk drives (HDDs) is provided. The actuator assembly comprises a base plate; a pivot; a voice coil motor (VCM) with an upper yoke and a lower yoke; and a cut-out insert having a predetermined stiffness and predetermined magnetic properties, wherein the cut-out insert corresponds to a cut-out recess of the base plate, and wherein the lower yoke of the VCM and the pivot are coupled to the cut-out insert.

### PRIORITY CLAIM

This application claims the benefit of priority from Singapore Patent Application No. 10201406341W filed on Oct. 3, 2014, the content of which is incorporated herein by reference in its entirety for all purposes.

### TECHNICAL FIELD

The present invention relates to the field of hard disk drives (HDDs). In particular, it relates to arrangements for the reduction of crosstalk in HDDs.

### BACKGROUND ART

The read/write mechanism in a conventional hard disk drive (HDD) generally comprises a voice coil motor (VCM) controlling a single actuator. Each actuator comprises one or more actuator arms, one or multiple voice coils with or without bobbin and one pivot cartridge bearing assembly. A suspension with one or multiple read/write magnetic heads is mounted at the end of each actuator arm. During a read/write operation, the VCM moves the actuator arm to position the read/write magnetic heads at a target location on a magnetic disk platter. The read/write operation is then performed at the target location.

Current research is directed towards increasing the data transfer rate of HDDs. Various methods of increasing the data transfer rate of the conventional HDDs have been proposed, including introduction of multiple actuators and increase in the rotations per minute (RPM) of the magnetic disk platters. While these methods provide a viable option of increasing the data transfer rate, they have several disadvantages. For instance, the presence of multiple actuators increases the amount of vibration within the HDD. The movements of multiple actuators introduce vibrations that propagate through the HDD and degrade the positioning accuracy of the read/write magnetic heads, leading to crosstalk. Multiple identical actuators may also operate at similar frequencies, which can result in mechanical resonance. Mechanical resonance of the actuators may cause substantial vibrations that affect the functional reliability of the HDD. The increase in RPM of the magnetic disk platters leads to turbulent air flow within the HDD which also increases vibration. The vibration may result in positioning error of the read/write magnetic heads and affect the read/write performance of the HDD. The vibrational signature of HDD is a consideration in consumer purchase decision. The vibrations from the introduction of multiple actuators and/or the increase in RPM of the magnetic disk platters may introduce unwanted noise that affects the user environment and HDD reliability thus reducing sales volume of HDDs.

Thus, what is needed is a hardware based crosstalk reduction for HDD that seeks to address some of the above problems. Furthermore, other desirable features and characteristics will become apparent from the subsequent detailed description and the appended claims, taken in conjunction with the accompanying drawings and this background of the disclosure.

### SUMMARY OF INVENTION

In a first aspect of the present invention, there is provided an actuator assembly for crosstalk reduction comprising: a base plate; a pivot; a voice coil motor (VCM) with an upper yoke and a lower yoke; and a cut-out insert having a predetermined stiffness and predetermined magnetic properties, wherein the cut-out insert corresponds to a cut-out recess of the base plate, and wherein the lower yoke of the VCM and the pivot are coupled to the cut-out insert.

In a second aspect of the present invention, there is provided an actuator assembly for crosstalk reduction comprising: a base plate; a pivot; a voice coil motor (VCM) with an upper yoke; and a cut-out insert having a predetermined stiffness and predetermined magnetic properties, wherein the cut-out insert corresponds to a cut-out recess of the base plate, and wherein a first magnet of the VCM and the pivot are coupled to the cut-out insert.

In a third aspect of the present invention, there is provided a multiple actuator, multiple hard disk drive (HDD) system comprising: a housing having a base plate; one or more rotatable disk platters within the housing and located above the disk plate, the one or more rotatable disk platters having magnetic disk media on one or both sides of each of the rotatable disk platters; a spindle motor assembly for rotating the one or more rotatable disk platters; and one or more actuator assemblies in accordance with the first and the second aspect of the present invention for flying a read/write head above each of the magnetic disk media for writing data thereto and reading data therefrom, wherein each of the cut-out inserts corresponds to a cut-out recess on the base plate.

### BRIEF DESCRIPTION OF DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1

FIG. 1 shows a perspective view of a dual actuator hard disk drive (HDD).

FIG. 2

FIG. 2A and FIG. 2B show a perspective exploded view of a base plate with lower yoke of a VCM coupled to cut-out inserts and a perspective exploded view of a base plate with lower yoke of a VCM integrally formed with cut-out inserts.

FIG. 3

FIG. 3A and FIG. 3B show a perspective exploded view of a base plate with damping adhesives or viscoelastic sheet layers between lower yoke of a VCM and cut-out inserts and a perspective assembled view of a base plate with lower yoke of a VCM and cut-out inserts.

FIG. 4

FIG. 4 shows a side cross sectional view of a voice coil motor (VCM).

FIG. 5

FIG. 5A and FIG. 5B show a simulation view of a dual actuator HDD and simulation results comparing the crosstalk from a dual actuator HDD comprising a base plate with cut-out inserts to a dual actuator HDD comprising a base plate without cut-out inserts.

FIG. 6

FIG. 6A and FIG. 6B show side cross sectional views of an axial field spindle motor with non-nested and nested stator coil configuration.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

The following detailed description is merely exemplary in nature and is not intended to limit the invention or the application and uses of the invention. Furthermore, there is no intention to be bound by any theory presented in the preceding background of the invention or the following detailed description. Herein a hardware based crosstalk reduction for hard disk drives (HDD) is presented in accordance with present embodiments having the advantages of reduced HDD vibration and crosstalk, greater functional reliability, higher performance and reduced vibrational noise in operating environment.

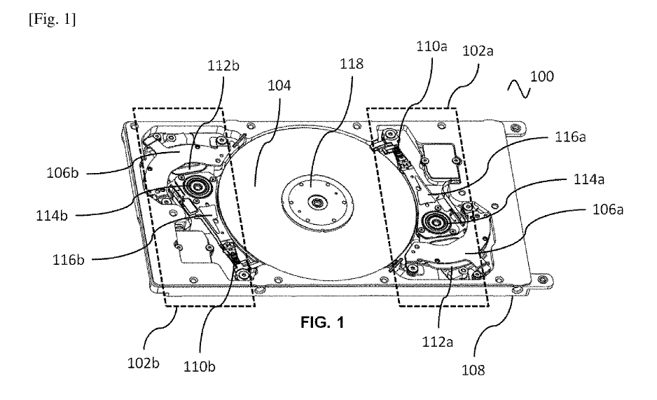

FIG. 1 shows a perspective view of a dual actuator hard disk drive (HDD). Referring to FIG. 1, the HDD 100 comprises a housing having a base plate 108, and two actuator assemblies 102a, 102b positioned at opposite sides of the one or more rotatable disk platters 104 driven by a spindle motor assembly 118. Each actuator assembly comprises one or more actuator arms 116a, 116b with one or multiple read/write heads 110a, 110b mounted onto a suspension at the end of each actuator arm 116a, 116b. Each of the actuator assemblies 102a, 102b is hinged on a pivot cartridge bearing assembly 114a, 114b and is driven by a voice coil motor (VCM) which comprises upper yoke 106a, 106b, voice coil 112a, 112b and lower yoke. In an embodiment, the VCM may comprise one or more magnets within the upper yoke 106a, 106b and lower yoke. In another embodiment, the two actuator assemblies 102a, 102b may be positioned within the base plate 108 such that the centers of the pivot cartridge bearing assembly 114a, 114b are aligned with the center of the spindle motor assembly 118. In other words, the centers of the pivot cartridge bearing assembly 114a, 114b and the center of the spindle motor assembly 118 are collinear. In other embodiments, the pivot cartridge bearing assembly 114a, 114b and the spindle motor assembly 118 may be assembled such that the centers of the pivot cartridge bearing assembly 114a, 114b and the center of the spindle motor assembly 118 do not form a straight line.

In an embodiment, asymmetrical actuator assemblies 102a, 102b and asymmetrical arms 116a, 116b may be used to reduce crosstalk during read/write operations in a dual actuator, multi disk HDD. The asymmetrical actuator assemblies 102a, 102b are designed such that the resonance and frequency response of each of the actuators 102a, 102b and actuator arms 116a, 116b do not correspond with the driving vibrational frequencies of the other actuator assemblies 102a, 102b and the actuator arms 116a, 116b. In other words, the resonance and frequency response of the individual actuator assemblies 102a, 102b and the actuator arms 116a, 116b are unique. In addition, the resonance and frequency response of the individual actuator assemblies 102a, 102b and the actuator arms 116a, 116b can be further optimized and tuned to reduce crosstalk and self-excitation. Dedicated actuator arms 116a, 116b may be assigned to specific one or more rotatable disk platters 104 to further reduce self-excitation and cross-talk.

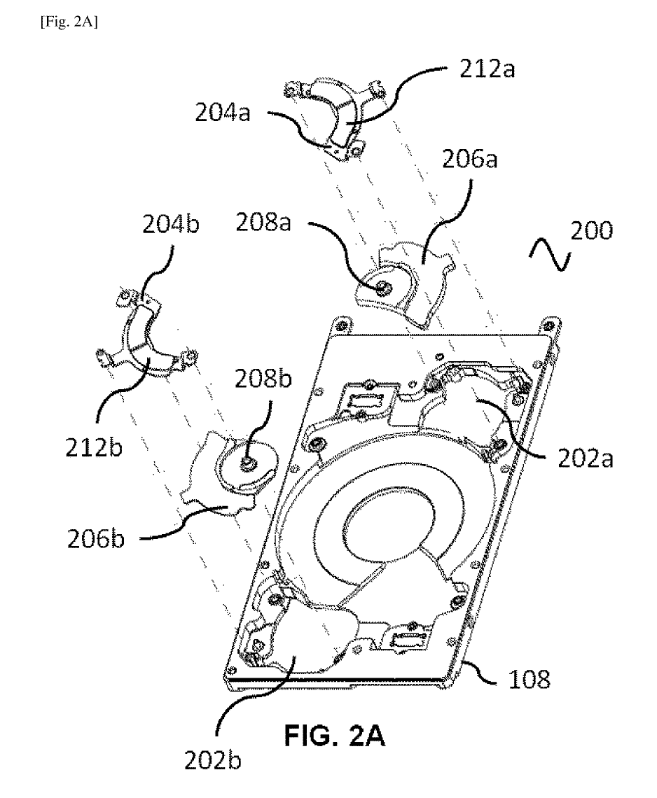

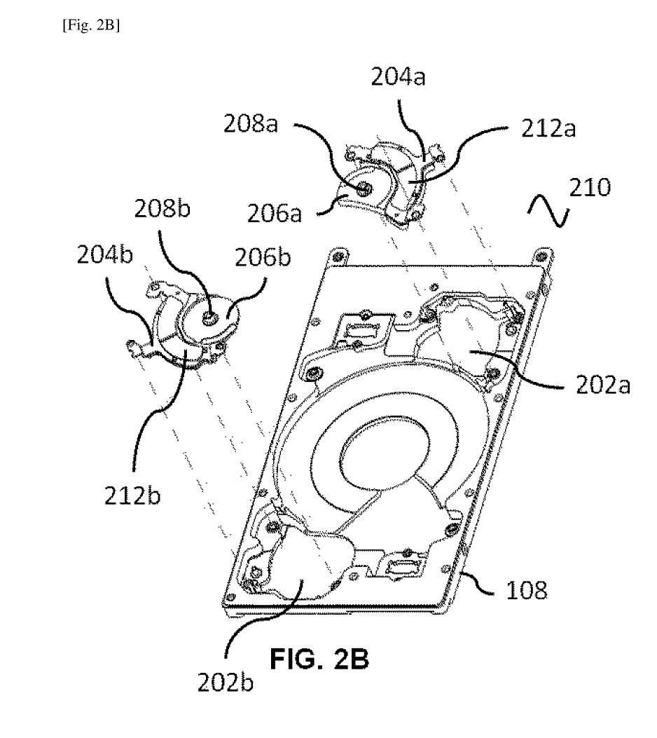

FIG. 2A and FIG. 2B show a perspective exploded view of a base plate with lower yoke of a VCM coupled to cut-out inserts and a perspective exploded view of a base plate with lower yoke of a VCM integrally formed with cut-out inserts.

Referring to FIG. 2A, the arrangement 200 shows a perspective exploded view comprising, the base plate 108, the lower yoke 204a, 204b of the VCM and pivot 208a, 208b coupled to the cut-out insert 206a, 206b having a predetermined stiffness and predetermined magnetic properties. The cut-out insert 206a, 206b corresponds to cut-out recess 202a, 202b of the base plate 108. Together with the VCM comprising the upper yoke 106a, 106b and the lower yoke 204a, 204b, the base plate 108, the pivot 208a, 208b, and the cut-out inserts 206a, 206b form the actuator assembly 102a 102b which is able to further reduce crosstalk in a HDD. In an embodiment, the predetermined stiffness of the cut-out insert 206a, 206b is sufficient to reduce crosstalk vibrations emanating from the actuator assembly 102a, 102b. Advantageously, the reduction in crosstalk vibrations increases the positioning accuracy of the read/write magnetic heads, leading to higher read/write performance. Reduced vibrations also increase the lifespan of mechanical components of the HDD and enhance HDD functional reliability. The cut-out insert 206a, 206b will also reduce vibrational noise generated by the HDD, and creates a more pleasant operating environment for an end-user.

Referring to FIG. 2B, the arrangement 210 shows an exploded view comprising, the base plate 108, the lower yoke 204a, 204b of the VCM and pivot 208a, 208b integrally formed with the cut-out insert 206a, 206b. In other words, the lower yoke 204a, 204b of the VCM and pivot 208a, 208b constitute a single component with the cut-out insert 206a, 206b. The single component may beneficially reduce number of component parts in the HDD, simplify supply chain management, facilitate manufacturing of HDD and lead to cost savings in HDD production.

In an embodiment, the VCM may comprise one or more magnets within the upper yoke 106a, 106b and a first magnet 212a, 212b within the lower yoke 204a, 204b wherein the predetermined magnetic properties of the cut-out insert 206a, 206b close the magnetic flux loop from the first magnet 212a, 212b and the another one or more magnets of the VCM. In another embodiment, both the upper yoke 106a, 106b and lower yoke 204a, 204b may contain one or more magnets mounted thereon. In yet another embodiment, the lower yoke 204a, 204b contain the first magnet 212a, 212b and the upper yoke 106a, 106b contain a second magnet. When the two magnets are suitably arranged, the VCM may be able to reduce out-of-plane forces which originate from movements of the actuator assemblies 102a, 102b during read/write operation. Thus, an actuator assembly 102a, 102b for crosstalk reduction may comprise a first magnet 212a, 212b of the VCM and the pivot 208a, 208b coupled to the cut-out insert 206a, 206b, the cut-out insert 206a, 206b, a base plate 108 and an upper yoke 106a, 106b. The cut-out insert 206a, 206b has a predetermined stiffness and predetermined magnetic properties and corresponds to a cut-out recess 202a, 202b of the base plate 108.

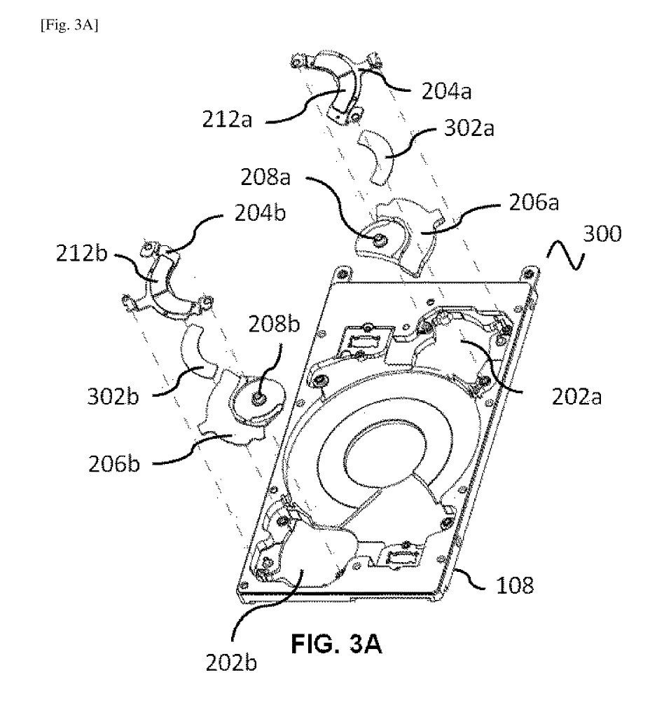

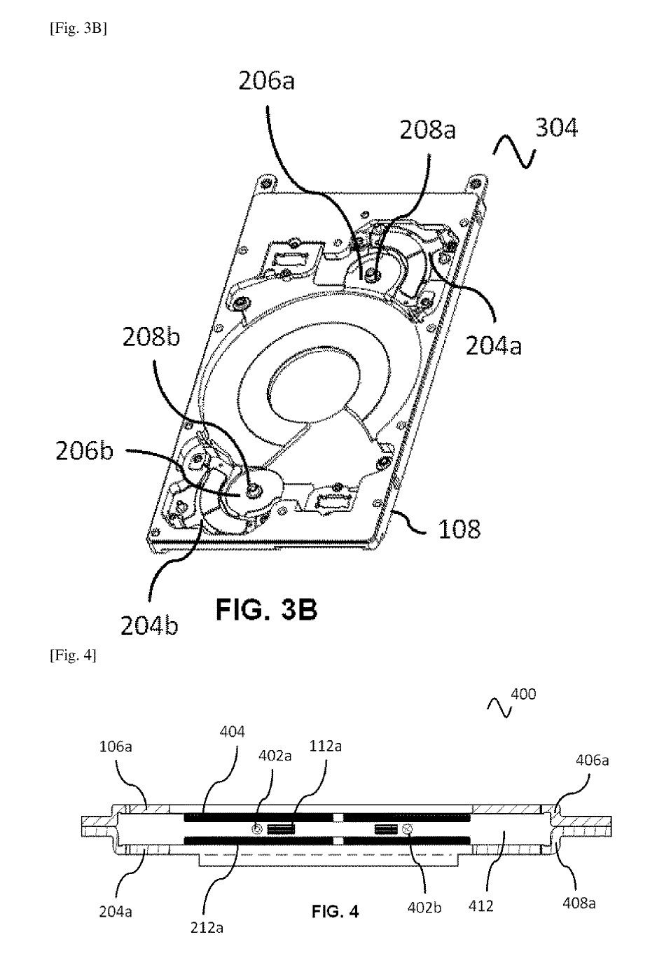

FIG. 3A and FIG. 3B show a perspective exploded view of a base plate with damping adhesives or viscoelastic sheet layer between lower yoke of a VCM and cut-out inserts and a perspective assembled view of a base plate with lower yoke of a VCM and cut-out inserts.

With reference to FIG. 3A, the arrangement 300 shows a perspective exploded view comprising, the base plate 108 with the lower yoke 204a, 204b and the pivot 208a, 208b coupled to the cut-out insert 206a, 206b. In an embodiment, a damping adhesive or a viscoelastic sheet layer 302a, 302b may be connected between the lower yoke 204a, 204b of the VCM and the cut-out insert 206a, 206b as shown in FIG. 3A. In another embodiment, the damping adhesive and the viscoelastic sheet layer 302a, 302b may be connected between the lower yoke 204a, 204b of the VCM and the cut-out insert 206a, 206b. The presence of the damping adhesive or viscoelastic sheet layer 302a, 302b and the cut-out insert 206a, 206b provide damping of the resonance and frequency response of the actuator assemblies 102a, 102b, which advantageously provides a means to reduce crosstalk due to mechanical vibration of the components of the HDD. In another embodiment, a first magnet 212a, 212b of the VCM may be mounted on the lower yoke 204a, 204b, and the damping adhesive or viscoelastic sheet layer 302a, 302b may be connected between the lower yoke 204a, 204b of the VCM and the cut-out insert 206a, 206b, which corresponds to a cut-out recess 202a, 202b of the base plate 108. In yet another embodiment, the damping adhesive or viscoelastic sheet layer 302a, 302b, lower yoke 204a, 204b and pivot 208a, 208b may be integrally formed with the cut-out insert 206a, 206b to further reduce number of component parts and enhance manufacturability of an HDD. In still yet another embodiment, the damping adhesive and the viscoelastic sheet layer 302a, 302b may be integrally formed with the lower yoke 204a, 204b and the pivot 208a, 208b to advantageously reduce crosstalk due to mechanical vibration of the components of the HDD.

In an embodiment, the base plate 108 may be constructed from a material that is malleable and easily stamped or molded or casted to form the base plate 108. The base plate 108 may comprise a material selected from a group comprising aluminum and steel. The cut-out insert 206a, 206b supporting the VCM and pivot cartridge bearing assembly 114a, 114b may be constructed from a material with predetermined stiffness and predetermined magnetic properties. The cut-out insert 206a, 206b may comprise a material selected from a group comprising steel, nickel and cobalt. In an embodiment, the predetermined stiffness of the cut-out insert 206a, 206b can be beneficially sufficient to reduce crosstalk vibrations. In addition, the predetermined magnetic properties of the cut-out insert 206a, 206b can sufficiently provide magnetic field closure of the magnets within the VCM. In other words, the cut-out insert 206a, 206b close the magnetic flux loop from the one or more magnets of the VCM in the actuator assembly 102a, 102b.

Referring to FIG. 3B, the arrangement 304 shows an assembled view of base plate 108 with the lower yoke 204a, 204b and the pivot 208a, 208b coupled to the cut-out insert 206a, 206b. In an embodiment, the arrangement 304 is comprised in a multiple actuator, multiple HDD system comprising a housing having a base plate 108, one or more rotatable disk platters 104 within the housing and located above the disk plate, the one or more rotatable disk platters 104 having magnetic disk media on one or both sides of each of the rotatable disk platters 104, a spindle motor assembly 118 for rotating the one or more rotatable disk platters 104 and one or more actuator assemblies 102a, 102b for flying a read/write head 110a, 110b above each of the magnetic disk media for writing data thereto and reading data therefrom, wherein each of the cut-out inserts 206a, 206b corresponds to a cut-out recess 202a, 202b on the base plate 108. In another embodiment, each of the multiple actuators may comprise a dedicated servo for crosstalk reduction and the dedicated servo may comprise a VCM and a dual stage actuator. In yet another embodiment, the VCM may be nested within the vertical flanges of the upper yoke 106a, 106b to further limit crosstalk between the multiple actuators.

FIG. 4 shows a side cross sectional view of a voice coil motor (VCM).

FIG. 4 shows a side cross sectional view of a voice coil motor (VCM) 400 having an upper yoke 106a with vertical flanges 406a provided above a lower yoke 204a with vertical flanges 408a. The upper yoke 106a and lower yoke 204a are assembled as shown in FIG. 4 to form a cavity 412 that comprises one or more first magnets 212a provided on lower yoke 204a, one or more second magnets 404 and voice coil 112a. In other words, the VCM comprising one or more first magnets 212a provided on lower yoke 204a, one or more second magnets 404 and voice coil 112a is nested within the vertical flanges 406a of the upper yoke 106a. In an embodiment, one or more first magnets 212a and one or more second magnets 404 are provided for reducing out-of-plane forces which originate from movements of the actuator assemblies 102a, 102b during read/write operation. The movements of actuators assemblies 102a, 102b are driven by currents 402a, 402b that flow in and out of plane of the voice coil 112a in FIG. 4. Advantageously, the reduction in out-of-plane forces decreases the vibration generated through the movements of the actuator assemblies 102a, 102b, and therefore enhances positioning accuracy of the read/write head 110a, 110b and performance of the HDD. In an embodiment, the lower yoke 204a, 204b may be integrally formed with the cut-out insert 206a, 206b as illustrated in FIG. 2B.

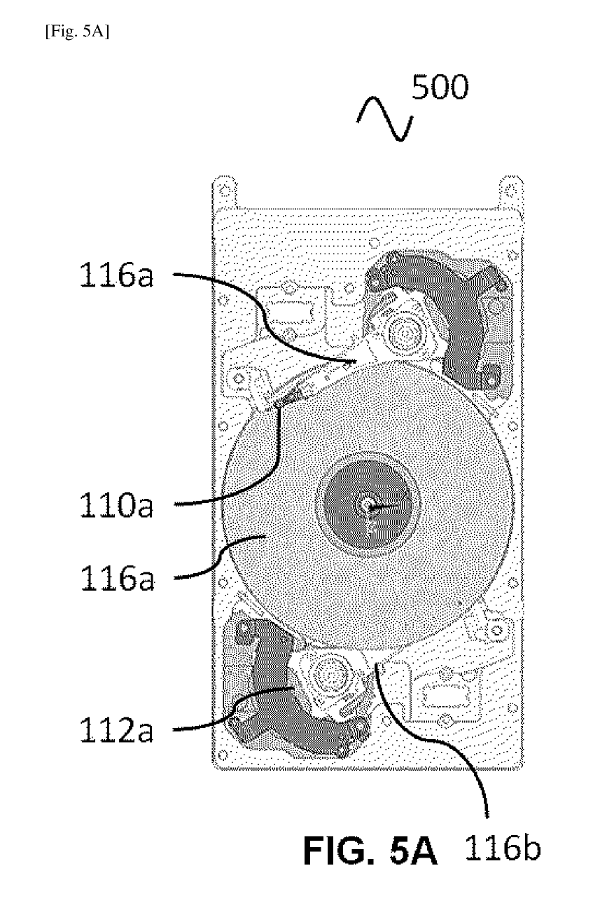

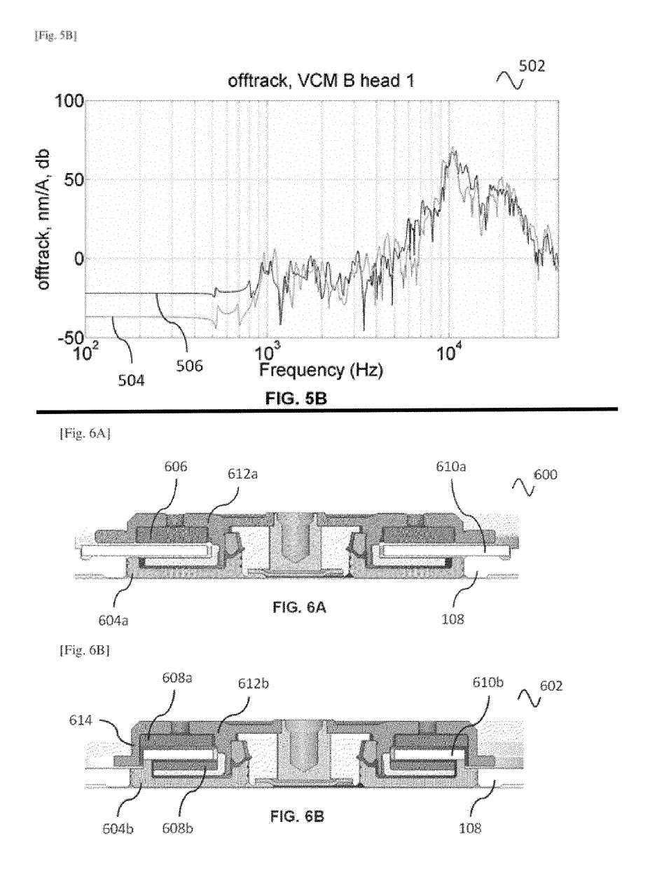

FIG. 5A and FIG. 5B show a simulation view of a dual actuator HDD and simulation results comparing the crosstalk from a dual actuator HDD comprising a base plate with cut-out inserts to a dual actuator HDD comprising a base plate without cut-out inserts.

FIG. 5A shows a simulation of a dual actuator HDD 500 comprising a base plate with cut-out inserts 206a, 206b in operation. In the simulation, off-track displacement of the read/write head 110a, 110b in response to a swept-sine electrical current input injected through the voice coil 112a, 112b of the opposite actuator assembly 102a, 102b is studied. In an embodiment, the swept-sine electrical current input is in injected through the voice coil 112a, 112b to position the one or multiples actuator arms 116a, 116b over the one or more rotatable disk platters 104 during a read/write operation. In an embodiment, the read/write heads 110a, 110b are assigned to alternate magnetic disk media on the disk platters 104. In other words, the read/write heads 110a, 110b are staggered such that head 110a reads/writes to the upper magnetic disk media of the disk platters 104 while the head 110b reads/writes to the lower magnetic disk media of the disk platters 104. The staggered arrangement favorably reduces windage-related vibrations and increase HDD reliability. The arrangement also beneficially fosters economics of scale due to common actuator arm design and construction.

Referring to FIG. 5B, graph 502 shows simulation results 504, 506 comparing the crosstalk from a dual actuator HDD with cut-out inserts 206a, 206b to a dual actuator HDD without cut-out inserts. In an embodiment, the simulation results 504, 506 represent the response functions of the off-track displacement of the read/write head 110a in response to a swept-sine electrical current input injected through the voice coil 112b of the opposite actuator assembly 102b. The off-track variable shown in the vertical axis of the graph 502 illustrates the positioning error (nm) of the read/write head 110a per unit current (A) through the voice coil 112b of the opposite actuator assembly 102b. A logarithm scale (dB) is applied the vertical axis to illustrate the order difference for the variable. The simulation result 504 shows improved frequency response in low frequencies for the dual actuator HDD with cut-out inserts 206a, 206b compared to the simulation result 506, which shows the nominal frequency response of the dual actuator HDD without cut-out inserts. The lower logarithmic magnitude registered with simulation result 504 compared to simulation result 506 in frequency bands below 1000 Hz implies lower positioning error for the read/write head 110a due to vibrations emanating from the opposite actuator assembly 102b when cut-out inserts 206a, 206b are used. Hence, simulation result 504 demonstrates the enhanced tolerance when cut-out inserts 206a, 206b are incorporated into the dual actuator HDD, with greater positioning accuracy and lower off-track. The damping of the low frequencies also beneficially reduces mechanical vibration crosstalk in HDD when used in the typical operating environment where vibrations in frequency spectrum of 5-500 Hz are encountered.

FIG. 6A and FIG. 6B show side cross sectional views of an axial field spindle motor with non-nested and nested stator coil configuration.

Referring to FIG. 6A, a cross sectional view of an axial field spindle motor 600 with non-nested stator coil configuration is shown. The axial field spindle motor 600 operates as an axis and rotates the one or more rotatable disk platters 104, enabling the read/write heads 110a, 110b to read/write to the magnetic disk media when positioned over the disk platters 104. The axial field spindle motor 600 includes a rotating portion and a stationary portion. The rotating portion comprises the spindle motor's top rotor bearing assembly 612a and magnet 606. The stationary portion comprises a base insert 604a coupled to base plate 108 and stator coil 610a. In an embodiment, the stator coil 610a extends beyond the spindle motor's top rotor bearing assembly 612a and the base insert 604a. In other words, the stator coil is in a non-nested configuration. In an embodiment, the stator coil 610a may comprise deposited-coil-on-substrate or several wound voice coils. In yet another embodiment, the axial field spindle motor 600 may comprise a stiffened base insert 604a coupled between the base plate 108 and the spindle motor to dampen vibration coupling between the base plate 108 and the spindle motor, thereby reducing crosstalk within the housing. The stiffened base insert 604a may comprise a material selected from a group comprising stainless steel while the base plate 108 may comprise a material selected from a group comprising aluminum and steel. The coupling of the base plate 108 with the stiffened base insert 604a advantageously reduces vibrations in the one or more rotatable disk platters 104 which in turn contribute to improved positioning accuracy and reduced crosstalk of the read/write magnetic heads 110a, 110b.

Referring to FIG. 6B, a cross sectional view of an axial field spindle motor 602 with nested stator coil configuration is shown. Similar to the axial field spindle motor 600 of FIG. 6A, the axial field spindle motor 602 includes a rotating portion and a stationary portion. However, the axial field spindle motor 602 comprises two magnets 608a and 608b. The upper magnet 608a is comprised in the rotating portion which includes a spindle motor's top rotor bearing assembly 612b. The lower magnet 608b is comprised in the stationary portion which includes a base insert 604b and stator coil 610b. In other words, the upper magnet 608a and lower magnet 608b is provided above and below the stator coil 610b respectively. The magnets 608a, 608b are thinner than the single magnet 606 shown in FIG. 6A. Use of two thinner magnets 608a, 608b advantageously compensates for air gap penalty and reduces vibrations in the one or more rotatable disk platters 104. In an embodiment, the stator coil 610a may be shortened to accommodate the downward extension of the flange 614 of the spindle motor's top rotor bearing assembly 612a as shown in FIG. 6A. The flange 614 of the spindle motor panel 612a converges with the base insert 604b to encompass the stator coil 610b. In other words, the stator coil is provided in a nested configuration.

In addition, in accordance with the present embodiments, hardware based crosstalk reduction methods realized through the use of the cut-out inserts and the corresponding cut-out recesses on the base plate have been proposed to reduce the amount of vibration and unintended crosstalk within the HDD.

Thus it can be seen that use of the cut-out inserts and the corresponding cut-out recesses on the base plate in accordance with the present embodiments have the advantages of reduced HDD vibration and crosstalk, greater HDD reliability, higher HDD performance and lower vibrational noise. While exemplary embodiments have been presented in the foregoing detailed description of the invention, it should be appreciated that a vast number of variations exist.

It should further be appreciated that the exemplary embodiments are only examples, and are not intended to limit the , applicability, operation, or configuration of the invention in any way. Rather, the foregoing detailed description will provide those skilled in the with a convenient road map for implementing an exemplary embodiment of the invention, it being understood that various changes may be made in the function and arrangement of elements and method of operation described in an exemplary embodiment without departing from the scope of the invention as set forth in the appended claims.

1. An actuator assembly for crosstalk reduction comprising:
a base plate;
a pivot;
a voice coil motor (VCM) with an upper yoke and a lower yoke; and
a cut-out insert having a predetermined stiffness and predetermined magnetic properties, wherein the cut-out insert corresponds to a cut-out recess of the base plate, and wherein the lower yoke of the VCM and the pivot are coupled to the cut-out insert.

2. The actuator assembly in accordance with claim 1, wherein the lower yoke of the VCM is integrally formed with the cut-out insert.

3. The actuator assembly in accordance with claim 1, wherein the VCM comprises one or more magnets, and wherein the predetermined magnetic properties of the cut-out insert close the magnetic flux loop from the one or more magnets of the VCM.

4. The actuator assembly in accordance with claim 1, wherein the predetermined stiffness of the cut-out insert is sufficient to reduce crosstalk vibrations.

5. The actuator assembly in accordance with claim 1, wherein the VCM comprises two magnets for reducing out-of-plane forces.

6. The actuator assembly in accordance with claim 1, wherein a damping adhesive is connected between the lower yoke and the cut-out insert.

7. The actuator assembly in accordance with claim 1, wherein a viscoelastic sheet layer is connected between the lower yoke and the cut-out insert.

8. The actuator assembly in accordance with claim 1, wherein a damping adhesive and a viscoelastic sheet layer are connected between the lower yoke and the cut-out insert.

9. An actuator assembly for crosstalk reduction comprising:
a base plate;
a pivot;
a voice coil motor (VCM) with an upper yoke; and
a cut-out insert having a predetermined stiffness and predetermined magnetic properties, wherein the cut-out insert corresponds to a cut-out recess of the base plate, and wherein a first magnet of the VCM and the pivot are coupled to the cut-out insert.

10. The actuator assembly in accordance with claim 9, wherein the VCM comprises another one or more magnets, and wherein the predetermined magnetic properties of the cut-out insert close the magnetic flux loop from the first magnet and the another one or more magnets of the VCM.

11. The actuator assembly in accordance with claim 9, wherein the predetermined stiffness of the cut-out insert is sufficient to reduce crosstalk vibrations.

12. The actuator assembly in accordance with claim 9, wherein the VCM comprises a second magnet for reducing out-of-plane forces.

13. The actuator assembly in accordance with claim 9, wherein a damping adhesive or a viscoelastic sheet layer is connected between a lower yoke of the VCM and the cut-out insert, the lower yoke having the first magnet mounted thereon.

14. The actuator assembly in accordance with claim 9, wherein the damping adhesive and the viscoelastic sheet layer are connected between a lower yoke of the VCM and the cut-out insert, the lower yoke having the first magnet mounted thereon.

15. A multiple actuator, multiple hard disk drive (HDD) system comprising:
a housing having a base plate;
one or more rotatable disk platters within the housing and located above the disk plate, the one or more rotatable disk platters having magnetic disk media on one or both sides of each of the rotatable disk platters;
a spindle motor assembly for rotating the one or more rotatable disk platters; and
one or more actuator assemblies of claim 1 for flying a read/write head above each of the magnetic disk media for writing data thereto and reading data therefrom,
wherein each of the cut-out inserts corresponds to a cut-out recess on the base plate.

16. The multiple actuator, multiple hard disk drive (HDD) system in accordance with claim 15, wherein the VCM is nested within the vertical flanges of the upper yoke.

17. The multiple actuator, multiple hard disk drive (HDD) system in accordance with claim 15, wherein each of the multiple actuators comprises a dedicated servo for crosstalk reduction.

18. The multiple actuator, multiple hard disk drive (HDD) system in accordance with claim 15, wherein the dedicated servo comprises a VCM and a dual stage actuator.

19. The multiple actuator, multiple hard disk drive (HDD) system in accordance with claim 15, further comprising a stiffened base insert coupled between the base plate and the spindle motor to dampen vibration coupling between the base plate and the spindle motor, thereby reducing crosstalk within the housing.
